(19) United States
(12) Patent Application Publication
(10) Pub. No.: US 2009/0243821 A1
(43) Pub. Date: Oct. 1, 2009

(54) Vehicle key fob with scanning device and display

(76) Inventors: Craig A. Tieman, Westfield, IN (US); Aidano C. Nascimento, Rochester, MI (US); Vincent Lee Brooks, Troy, MI (US); Mark Piche, Troy, MI (US); Alicia Maria Vertiz, Rochester Hills, MI (US); Rana Balci, Troy, MI (US)

Correspondence Address: DELPHI TECHNOLOGIES, INC., M/C 480-410-202, PO BOX 5052, TROY, MI, 48007, US

(21) Appl. No.: 12/079,110

(22) Filed: Mar. 25, 2008

(51) Int. Cl. B60R 25/10; G06K 9/00

(52) U.S. Cl. 340/426.36; 382/104

(57) ABSTRACT

An apparatus and method for capturing and displaying images in a vehicle RKE fob includes an imager carried on the fob for capturing images for storage in a memory coupled to a fob control. The stored images are viewable on a display on the fob and are scannable for commercial use. The imager may provide one or more axis movement of the display by movement of a user's finger over the image control display and selection of stored images. The imager and image memory storage may also be used for biometric data comparison.

### BACKGROUND

The present invention relates, in general, to vehicle wireless remote entry (RKE) key fobs.

Wireless key fobs are widely used for vehicle access and to remotely control vehicle functions, such as locking or unlocking the door, remote engine starting, flashing of emergency horns and lights, as well as to control, locate and provide information feedback. The use of such wireless key fobs is being extended to longer range, bi-directional data transmission, and information displays on the fob.

Key fobs are typically attached to a key ring which holds keys and, frequently, numerous merchant customer program ID cards which contain barcodes. These cards are typically used at checkout stations in retail stores where they are scanned to identify the customer and apply purchase credit toward the customer's frequent shopper account. Consumers also frequently carry many other credit card-sized merchant cards with barcodes on them in their purse or wallet for similar purposes.

### SUMMARY

A method for providing capture and display of images via a remote keyless entry fob includes the steps of providing a housing with input members for generating signals corresponding to vehicle control functions, wirelessly transmitting a signal from the fob corresponding to the selected input member, capturing an image by an image-capturing device carried on the fob, storing the captured image in a memory carried by the fob, and displaying the image in a display carried by the fob.

The method further includes scrolling through a plurality of captured images stored in the memory for displaying a selected captured image on the display.

The method also includes the step of capturing barcode images.

The step of capturing images further includes the step of capturing biometric information of a user.

A fob for a vehicle remote keyless entry apparatus includes a housing, one or more input members carried on the housing for selecting a vehicle functions, a transmitter carried by the housing and transmitting a data signal corresponding to the selected vehicle function upon activation of one of the input members by a user, a control carried in the housing and providing signals corresponding to the vehicle control function selected by an input member to the transmitter, a memory coupled to the control for storing images, and an imager, carried by the housing, for capturing digital representations of images within a field of view of the imager.

The images may be barcodes.

The imager may provide an axis movement input to the control for controlling the display of images on the display.

The control maybe operative to perform a biometric comparison of an image in a field of view of the imager with a stored biometric image.

### BRIEF DESCRIPTION OF THE DRAWING

The various features, advantages, and other uses of the present invention will become more apparent by referring to the following detailed description and drawing in which:

FIG. 1 is a pictorial representation of a prior art wireless remote entry key fob carried on a key ring with consumer merchant identification tags;

FIG. 2 is a front elevational view of a wireless key fob with imager and display; and

FIG. 3 is a block control diagram of the fob shown in FIG. 2.

### DETAILED DESCRIPTION

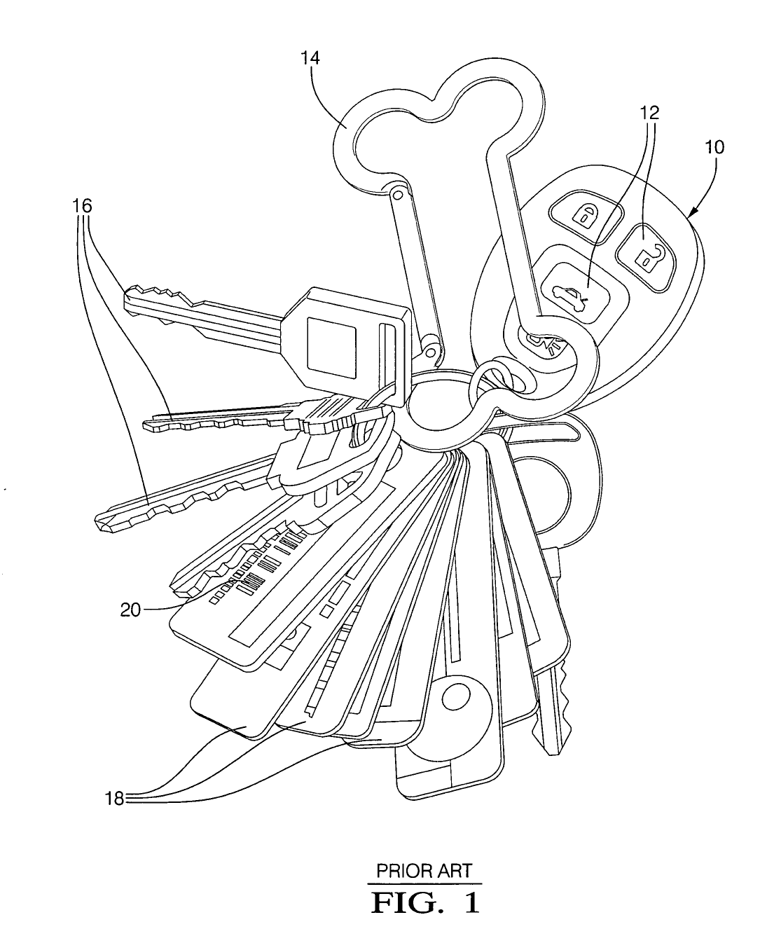

Referring now to FIG. 1, a prior art of use of a key fob 10 which provides wireless remote activation of various vehicle functions will be first described.

The fob 10, which can take any shape and operative construction, has one or more input members or pushbuttons 12 which, when activated or depressed cause the fob control to generate and transmit a wireless signal to a remote keyless entry unit mounted in a vehicle. The remote keyless entry, RKE, not shown, is connected to various vehicle control devices, such as the vehicle door locks, the vehicle window drive mechanism, the engine ignition, the vehicle horn and/or lights, etc. Upon receiving a signal from the fob 10, the vehicle RKE identifies and authenticates the fob signal, decodes the signal to determine the selected vehicle function, and then generates control signals which are sent to the selected vehicle control device for implementing the selected vehicle function.

As shown in FIG. 1, the fob 10 is usually mounted on a key ring 14 along with one of more keys 16. In addition, one or more merchant customer program ID tags 18 can also be used are commonly mounted on the key ring 14 or carried in the user's purse or wallet. Tags 18 can also be used in a credit card-sized card. Each of the tags 18 has a unique, discrete, customer identifier 20 which typically is in the form of a bar code.

The customer ID tags or cards 18 are used at the check out station of a retail store or at a gas station pump where they are scanned to identifier the customer and to apply a purchase credit to the customer's frequent shopper account or to act as a credit or debit card for the transaction. As seen in FIG. 1, the number of separate articles carried on a key ring 14 can reach unwieldy proportions with keys 16 for various purposes and a large number of merchant customer ID tags 18.

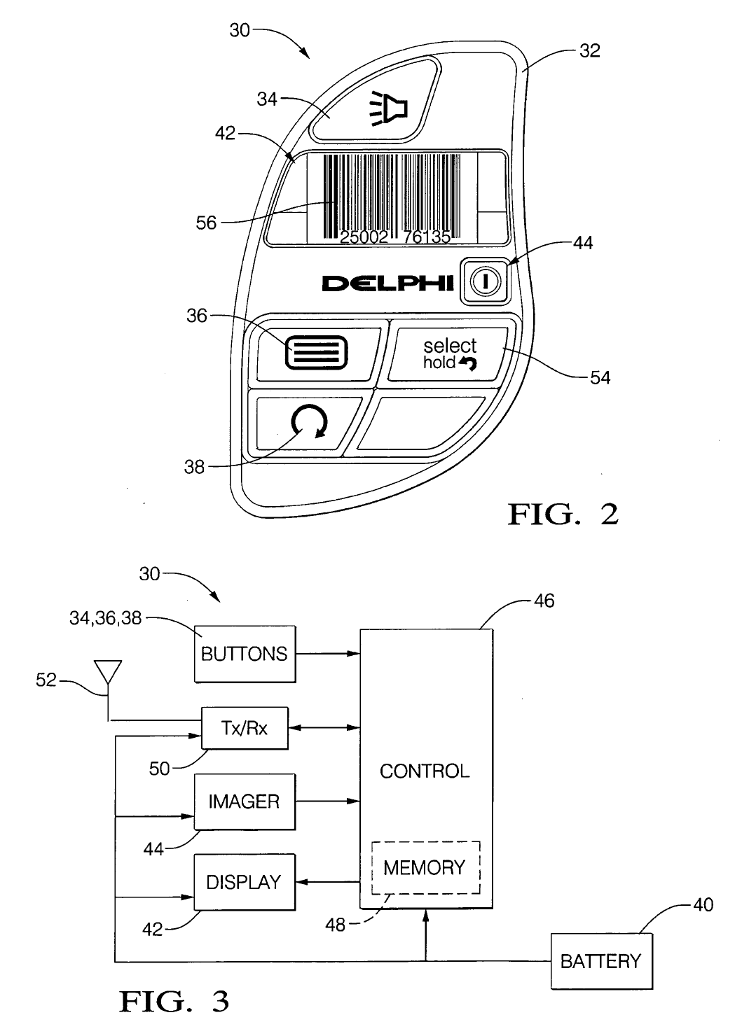

Referring now to FIGS. 2 and 3, there is depicted an RKE fob 30 which is capable of integrating the plurality of merchant customer ID tags 18 carried on a key ring into the fob 30 itself.

The fob 30 has a housing 32 of any shape. One or more input members or pushbuttons, with input members 34, 36, 38, and 54 shown by way of example only in FIG. 2, are mounted on the housing 32 and, when activated or depressed, cause a control 46 disposed within the fob housing 32 to generate and transmit a wireless signal corresponding to which input member 34, 36, 38, and 54 was activated to the vehicle RKE for activation of a selected vehicle function or to control the image capture, image output or display.

The input member 34 can be a conventional emergency input causing flashing of the vehicle lights and/or vehicle horn to assist the user in locating the vehicle or to generate an emergency alarm signal.

The input member 38 is for a remote engine start function.

The housing 32 contains a power source, such as a battery 40, shown in FIG. 3. The battery 40 can be a replaceable storage battery, a rechargeable battery or any other electrical power source, such as a solar cell, inductive current generating transformer coil, etc.

As shown in FIG. 2, a display 42 is carried in the housing 32. The display 42 can use any display technology, such as electro-phoretic (i.e., electronic paper), which is highly visible under all ambient light conditions, including bright ambient light occurring during daylight as well as being able to be scanned by retail bar code scanners.

A scanning device 44 is also carried on the housing 32. The scanning device 44 or scanner, such as an imager, biometric sensor, etc., all hereafter referred to as an “imager 44” is capable of creating a digital image of article within the field of view of the imager 44 which transfers bitmapped images, photographs, or bar-coded data from the control 46 to the memory 48. The data/images could come from the merchant consumer ID cards 18 and be in the form of a barcode 56, shown in FIG. 2, or other personal information visually carried by a consumer and used to identify the consumer in a merchant customer frequent shopper program.

The memory 48 can be any internal or removable non-volatile memory, such as erasable ROM, etc. The memory 48 stores the program executed by the processor of the control 46 as well as the personal data or images generated by the imager 44.

Input member 36, by example only, creates a menu select function that allows a user to scroll through a menu of listed choices on the display 42 by repeated depressions of the menu select button 36 or a continuous depression of the button 36 which then causes a continuous incremental advance of the menu on the display 42.

The menu can display different vehicle control functions, such as door or hatch lock and unlock, windows down, etc.

Once the user has decided on a particular menu selection, the user can depress the select/hold input member or button 54. The select/hold button 54 has a dual function in which a quick depression selects a menu item from the display 42; while a press and hold depression causes a return to the top of the menu.

Alternately, repeated presses of the menu button 36 scrolls vertically on a menu on the display 42; while repeated presses of the select/hold button 54 moves the display curser horizontally in a menu on the display 42.

The control program executed by the control 46 also enables the control 46 to start a scanned image sequence. Upon depression of an appropriate human-machine interface or input member 54 on the fob housing 32, the user will be provided with a short time period, such as one or two seconds, for example to place the imager 44 over the image to be scanned, such as the barcode 20 on a merchant consumer ID card 18. The imager 44 would then capture the image and the control 46 will transfer and store the image in the memory 48 along with appropriate merchant identification which may be part of the barcode 56 or as a separate component of the scanned image.

During the scanned image sequence the scanned image can be immediately presented on the display 42 for verification that the entire image has been captured, that the image scanning process has been completed, etc. In addition, an audible or visual signal can be provided by the fob 30 at the completion of the image scanning process to indicate that an image has been captured.

Suitable image processing software can be employed by the control 46 to size the captured image to the size of the display 42, enhance its contrast with the background of the display 42, change the color of the displayed image, etc.

When the user desires to provide a scanned image, such as a barcode 56, to a merchant, the user presses the menu and select buttons 36 and 54 to cause the control 46 to enter an image output sequence in which the control 46 causes the barcode or image associated with the selected item in the menu to be displayed. When the desired image, such as barcode 56 shown in FIG. 2, is visible on the display 42, the user hands the fob 32 to the merchant who then places the display 42 over the checkout barcode scanner for reading of the barcode image 56.

In another aspect, the imager 44 can be used as a one or two axis input device for menu navigation on the display 42. The user could place his or her finger over the imager 44 and all lateral and/or longitudinal movements would be detected and used for scrolling or menu navigation of menus visible on the display 42 or of all of the images stored in the memory 48 until the desired image appears on the display 42. Alternatively, a separate input member, such as a ball or a thumbwheel, can be provided on the fob housing 32 for image or menu navigation.

In another aspect, the imager 44 can be used for user fingerprint recognition to provide various control capabilities. For example, fingerprint recognition can be used to identify which vehicle driver is presently using the fob for vehicle personalization and memory preset activation, i.e., seat position, steering wheel position, climate control presets, radio presets, etc., as well as to secure access to personal data stored within the memory 48 of the fob 30.

What is claimed is:

1. A method for capturing and displaying images by capturing a remote keyless entry fob comprising the steps of:
providing a housing with at least one input member for generating a signal corresponding to at least one vehicle control function;
wirelessly transmitting a signal from the housing corresponding to a selected input member;
capturing an image by an image-capturing device carried on the fob;
storing the captured image in a memory carried in the housing; and
displaying the image in a display carried in the housing.

2. The method of claim 1 the step of:
scrolling through a plurality of images stored in the memory for displaying a selected stored image on the display.

3. The method of claim 1 wherein the step of capturing images further comprises the step of:
capturing barcode images.

4. The method of claim 1 wherein the step of capturing images further comprises the step of:
capturing biometric information of a user.

5. A vehicle remote keyless entry fob comprising;
means for providing a housing with at least one input member for generating a signal corresponding to at least one vehicle control function;
means for wirelessly transmitting a signal from the housing corresponding to a selected input member;
means for storing captured image by an image capturing device carried on the fob;
means for capturing an image in a memory carried by the fob; and
means for displaying the image in a display carried in the housing.

6. A vehicle remote keyless entry fob comprising:
a housing;
at least one input member carried on the housing for selecting at least one vehicle function;
a transmitter carried by the housing and for transmitting a data signal corresponding to the selected vehicle function by activation of the input member;
a control carried in the housing and providing a signal corresponding to the vehicle control function selected by the input member to the transmitter;
a memory, coupled to the control, for storing images; and
an imager, carried by the housing, for capturing digital representations of images within a field of view of the imager.

7. The apparatus of claim 6 wherein:
the images are barcodes.

8. The apparatus of claim 6 wherein:
the imager provides at least one movement input to the control for controlling the display of images on the display.

9. The apparatus of claim 6 further comprising:
the control storing the digital representations of images in the memory.

10. The apparatus of claim 6 wherein:
the control is operative to perform a biometric comparison of an image in a field of view of the imager with a stored biometric image.
